(19) United States
(12) Patent Application Publication
(10) Pub. No.: US 2015/0215614 A1
(43) Pub. Date: Jul. 30, 2015

(54) IMAGING SYSTEM AND METHOD

(71) Applicant: SONY CORPORATION, Tokyo (JP)

(72) Inventor: Sarah Elizabeth Witt, Winchester (GB)

(73) Assignee: SONY CORPORATION, Tokyo (JP)

(21) Appl. No.: 14/419,545

(22) PCT Filed: Aug. 14, 2013
(86) PCT No.: PCT/GB2013/052162

§ 371 Date: Feb. 4, 2015

(30) Foreign Application Priority Data
Sep. 14, 2012 (GB) 1216484.4

(51) Int. Cl. H04N 13/04; G02B 23/24; H04N 13/02

(52) U.S. Cl. CPC H04N 13/0497; H04N 13/0239; G02B 23/2415

(57) ABSTRACT

A surgical imaging system including: an image capturing device operable to capture an image of a scene; a distance extraction device operable to extract distance information from a point in the scene, the distance information being the distance between the image capturing device and the point in the scene; an image generating device operable to generate a pixel, the generated pixel being associated with a pixel in the captured image and a value of the generated pixel being derived from the distance information; an image combining device operable to combine the generated pixel with the captured image, wherein the generated pixel replaces the pixel of the captured image it is associated with to form a composite image; and an image display device operable to display the composite image.

### BACKGROUND

1. Field of the Disclosure

The invention relates to an inspection imaging system, and a medical imaging system, apparatus and method.

2. Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the invention.

When performing surgery on an internal area of a human body it is advantageous to reduce the number and size of incisions or intrusions into the body. To achieve this, surgical methods that involve endoscopy are often utilised. Endoscopy is a method of medical imaging which utilises an endoscope that is directly inserted into the body to capture and display an internal image of a body on a display device such as a television monitor. Surgeons performing surgery using an endoscope view the image captured by the endoscope on a display device in order to guide their actions. Surgery that involves endoscopy, which also referred to as key-hole surgery or minimally invasive surgery, typically requires smaller incisions than conventional methods such as open surgery because direct line of sight viewing of an area upon which the surgery is taking place is not required.

Due to the delicate and precise nature of surgery, providing a surgeon with an accurate image of the area upon which surgery is taking place is desirable. Typically, images reproduced by an endoscope on a display device have been two-dimensional and therefore have not provided surgeons with adequate depth perception. Consequently, stereoscopic three-dimensional (S3D) endoscopes that are able to present an S3D image to a surgeon have recently been produced. However, a number of problems may arise when using S3D endoscopy. For example, due to the small enclosed spaces within which endoscopes typically operate the distance between the endoscope and the area being imaged is likely to be small compared to the distance between apertures of the S3D endoscope. Consequently, a resulting S3D image may be uncomfortable to view, thus potentially reducing the accuracy of the movements of a surgeon and increasing surgeon fatigue. Furthermore, different surgeons will have varying abilities to appropriately view the S3D images produced by a 3SD endoscope and therefore different surgeons will experience a varying degree of benefit from viewing S3D images when performing surgery.

### SUMMARY

According to one aspect of the present invention, a surgical imaging system is provided, the surgical imaging system comprising an image capturing device operable to capture an image of a scene and a distance extraction device operable to extract distance information from a point in the scene, where the extracted distance information is a distance between the image capturing device and the point in the scene. The surgical image system also comprises an image generating device operable to generate a pixel, wherein the generated pixel is associated with a pixel in the captured image and a value of the generated pixel is derived from the distance information. An image combining device is operable to combine the generated pixel with the captured image, wherein the generated pixel replaces the pixel of the captured image it is associated with to form a composite image. An image display device is then operable to display the composite image. The surgical imaging system provides surgeons with an alternative means to view depth information of a scene where surgery is taking place without viewing a stereoscopic 3D (S3D) image. The depth information is displayed in the composite image and is conveyed by generating and displaying pixels whose values are based a distance extracted from the scene. Displaying distance and depth information in this manner avoids problems associated with displaying S3D images to a surgeon. Problems that may include an image having too much depth, all features of the scene appearing in front of the display device, and the differing abilities individual surgeons have to comfortably view S3D images.

In another embodiment of the present invention, the surgical imaging system includes an S3D image capturing device operable to capture a pair of stereoscopic images of the scene. The use of a S3D image capturing device allows depth information on points in the scene to be extracted from the captured images and used to generate the pixel. The inclusion of an S3D endoscope also allows existing endoscopes to be used and for the composite image to be shown alongside the S3D image so that the surgeon can choose which image of the scene to view.

In another embodiment of the present invention, the surgical imaging device includes an image selecting device that is operable to select one of a pair of captured S3D images in order to form the captured image that is combined with the generated pixel. The inclusion of an image selecting device allows a single image to be used as the captured image when multiple images have been captured by the image capturing device.

In another embodiment of the present invention, where the image capturing device is a S3D image capturing device, the distance extracting device of the surgical imaging system is operable to extract the distance between the image capturing device and the point in the scene from a pair of captured S3D images. The extraction of the distance from a pair of S3D images enables the system to obtain distance information without the need for a dedicated distance measuring device, therefore enabling existing S3D image capturing devices to be used with the surgical image system.

In another embodiment of the present invention the image generating device of the surgical imaging system is operable to generate a plurality of pixels, the plurality of pixels forming a numerical distance measurement and the numerical distance measurement being a measurement between the point in the scene and a reference point. The generation of a plurality of pixels which form a numerical distance measurement provides a surgeon with an easy to interpret distance measurement in the composite image between two points in the scene. This may be beneficial when the surgeon is attempting position an object in a patient or when trying to ensure that two features of the scene do not come into close proximity.

In another embodiment of the present invention, the image generating device of the surgical imaging system is operable to generate a plurality of pixels, a colour of each of the plurality of pixels being derived from the distance information. A colour based visualisation in the composite image of distances in a scene provides a surgeon with intuitive and easy to interpret distance information without viewing a S3D image or placing numerical measurements in the composite image.

In another embodiment of the present invention, the image generating device of the surgical imaging system is operable to generate a plurality of pixels, where a chrominance saturation of each of the plurality of pixels is derived from the distance information. A chrominance based visualisation in the composite image of distances in a scene provides a surgeon with intuitive and easy to interpret distance information without viewing a S3D image or placing numerical measurements in the composite image. Added to this, varying the chrominance of the image dependent on distance preserves the colour of the scene in the composite image, thus ensuring that features of the scene which have distinctive colours are easily identifiable by the surgeon.

In another embodiment of the present invention, the distance extraction device of the surgical imaging system comprises a distance sensor operable to directly measure a distance between the image capturing device and the point in the scene, the measured distance forming the distance information. The inclusion of a dedicated distance measuring device allows a distance to a feature in the scene to be measured without requiring an S3D image and using associated distance extraction techniques. Consequently, the size of the image capturing device may be reduced compared to an S3D image capturing device because only one aperture is required.

In another embodiment of the present invention, the surgical imaging system includes a distance determination device which is operable to transform the distance information. The transformed distance information forms the distance information and corresponds to a distance between a reference point and the point in the scene, as opposed to a distance between the image capturing device and the point in the scene. The distance determination device allows distances between points other than the image capturing device to be measured and displayed to a surgeon therefore providing the surgeon with additional information which would not otherwise be available. The provision of additional information may in turn improve the accuracy and quality of surgery performed by the surgeon.

In another embodiment of the present invention, the reference point with which distance are measured with respect to may be defined by a surgeon using the surgical imaging system. The manual definition of a reference point allows a surgeon to measures distances in the scene relative to a point of their choice, for instance this reference point may be an incision in the scene. This embodiment therefore allows the surgeon to tailor the composite image to their needs, thus potentially improving the quality and accuracy of surgery they are performing.

According to another aspect, there is provided a medical imaging device comprising: an image capturing device operable to capture an image of a scene; a distance extraction device operable to extract distance information from a point in the scene, the distance information being the distance between the image capturing device and the point in the scene; an image generating device operable to generate a pixel, the generated pixel being associated with a pixel in the captured image and a value of the generated pixel being derived from the distance information; an image combining device operable to combine the generated pixel with the captured image, wherein the generated pixel replaces the pixel of the captured image it is associated with to form a composite image; and an output operable to provide the composite image to an image display device.

According to another aspect, there is provided an imaging inspection device comprising: an image capturing device operable to capture an image of a scene; a distance extraction device operable to extract distance information from a point in the scene, the distance information being the distance between the image capturing device and the point in the scene; an image generating device operable to generate a pixel, the generated pixel being associated with a pixel in the captured image and a value of the generated pixel being derived from the distance information; an image combining device operable to combine the generated pixel with the captured image, wherein the generated pixel replaces the pixel of the captured image it is associated with to form a composite image; and an output operable to provide the composite image to an image display device.

Where the above features relate to apparatus, system or device features as the case may be, in other embodiments, method features are also envisaged. Further appropriate software code and storage medium features are also envisaged.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a schematic diagram of an example surgical imaging system.

FIGS. 2a and 2b show schematic diagrams of example two-dimensional image capturing devices.

FIGS. 3a and 3b show schematic diagrams of example stereoscopic three-dimensional image capturing devices.

FIG. 4 shows a schematic diagram of a surgical imaging system according to an embodiment of the invention.

FIG. 5 shows a schematic diagram of a structure of a processor according to an embodiment of the invention.

FIG. 6 shows a flow chart illustrating a method of operation for a surgical imaging system according to an embodiment of the invention.

FIGS. 7a and 7b show schematic diagrams of example stereoscopic images captured by the image capturing device of FIGS. 3a and 3b.

FIG. 8 shows a schematic diagram of an example image capturing device according to an embodiment of the invention.

FIG. 9 shows a schematic diagram of a composite image according to an embodiment of the invention.

FIG. 10 shows a schematic diagram of a composite image according to an embodiment of the invention.

FIG. 11 shows a schematic diagram of a composite image according to an embodiment of the invention.

### DESCRIPTION OF THE EMBODIMENTS

Referring now to the drawings, wherein like reference numerals designate identical or corresponding parts throughout the several views.

When performing surgery it is beneficial if a surgeon is provided with accurate and detailed images of an area upon which surgery is being performed. Consequently, surgical imaging is a factor contributing towards a surgeon performing an accurate and successful surgical procedure. The term surgery herein refers to a range of surgical procedures including non-invasive (including observation), minimally invasive and invasive surgery. Accordingly, surgical imaging refers to imaging used in connection with these surgical techniques.

One example of a surgical imaging technique is endoscopy. Although endoscopes themselves are image viewing and capturing devices, they are often used in surgical procedures termed minimally invasive surgery. Surgery which uses an endoscope overcomes a need for a direct line of-sight view of an area upon which surgery is being performed. As a result, smaller incisions may be required which in turn may lead to reduced recovery times as well a reduced possibility of infection. Due to these advantages, endoscopic surgery or minimally invasive surgery is a popular surgical technique.

Although the following discusses surgical imaging and image capturing devices in the context of endoscopes, the invention is not so limited. For example, the following discussion is equally applicable to laparoscopes and other forms of surgical imaging and devices such as surgical microscopes.

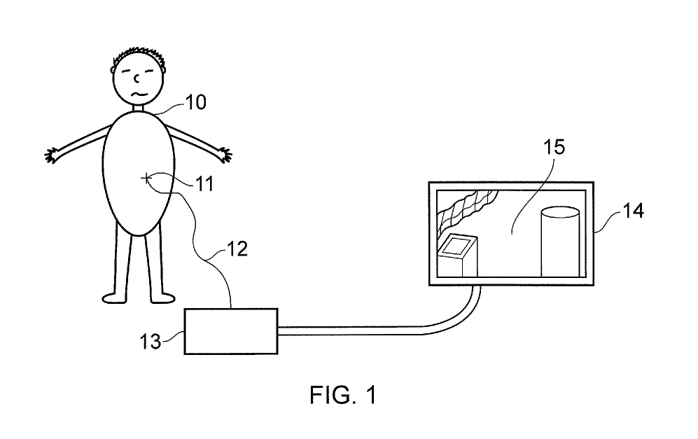

FIG. 1 shows a schematic diagram of an example surgical imaging system. In FIG. 1 an image capturing device is positioned in a patient 10 through an incision 11 or an orifice so to allow a surgeon to view an internal scene of the patient without requiring a direct of-line sight view. The image capturing device captures digital images of the scene within the patient and, via a communication line 12, communicates the captured images to a processor 13. A number of alternative communications lines 12 may be utilised in the system illustrated in FIG. 1. For instance the line may be formed from any material suitable to communicate information representing a captured image to the processor 13 such as an electrical cable or an optic fibre. The communication line may also be implemented wirelessly using any suitable wireless access protocol such as Bluetooth or WIFI. The processor 13 is operable to process the captured images,output the processed images to an image display device and present the processed images 15 on an image display device 14 for a surgeon to view. This image capturing and display process may happen in |real|[g1]-time such that a real-time video of the scene formed from a sequence of captured images is displayed by the display device. In some examples the display device 14 may form part of a head-mountable display (HMD) which is worn by a surgeon. Presenting the captured images via an HMD may result in a number of advantages, for instance it may reduce peripheral distractions a surgeon experiences during surgery and as well as providing the surgeon with a more immersive viewing experience. In other examples the captured images may be streamed over a wide-area network such as the internet so that surgeons in a different location to where the surgery is taking place can perform remote consultation. For example, when there is a limited number of specialist surgeons for a particular procedure the streaming of captured images may mean that a specialist surgeon does not have to travel to where the surgery is taking place in order to assist or consult.

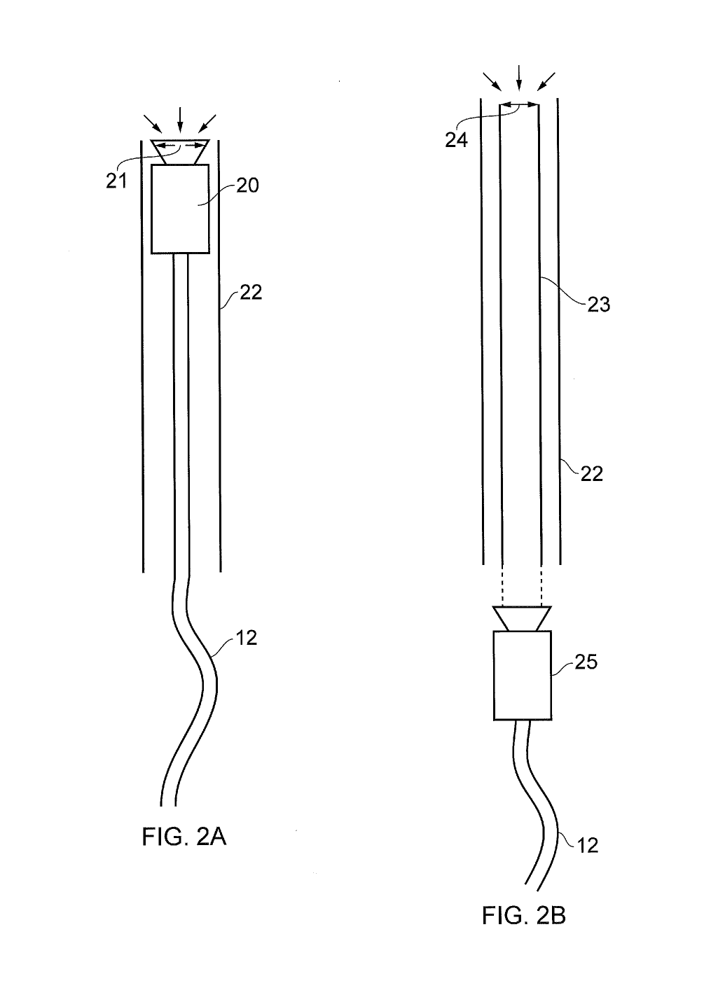

A number of devices may act as an image capturing device in the surgical imaging system illustrated in FIG. 1. FIGS. 2a and 2b illustrate two alternative two-dimensional (2D) image capturing devices. In FIG. 2a the image capturing device includes a digital imaging device 20 and a single aperture 21. The digital imaging device digitises information carried by light from a scene to produce a sequence of captured images which are communicated to the processor 13 via the communication line 12. Although the image capturing device is illustrated as being contained within a straight main body 22, the main body may also be flexible such that the image capturing device can be more easily manoeuvred within a patient. The digital imaging device may be any device that is suitable to produce a sequence of digital captured images from the light from the scene, for example, the digital imaging device 20 may be a charge-coupled device or an active pixel sensor.

In FIG. 2b the image capturing device includes one or more optic fibres 23 that form a single aperture 24, and a digital imaging device 25 that is located an increased distance away from the patient-end of the surgical imaging system compared to the digital imaging device 20 in FIG. 2a. The optic fibres convey light from the scene to the digital imaging device 25 which digitises information carried by the light to form a sequence of captured images. These images are then communicated to the processor 13 via the communication line 12. As in FIG. 2a, although the image capturing device is illustrated as being contained within a straight main body 22, the main body may be flexible so that it can be more easily manoeuvred within the patient. Also as in FIG. 2a, the digital imaging device may be any device that is suitable to produce a sequence of digital captured images from the light from the scene.

Due to a reduced size of incisions associated with use of the system and devices depicted in FIGS. 1, 2a and 2b and a substantial opaqueness of human tissue, little or no light from an external environment of a patient will illuminate a scene within the patient. Therefore, an internal light source is required if the image capturing device is to provide useful captured images. Consequently, although not shown in FIGS. 2a and 2b, a light source operable to illuminate the scene may be located at the patient-end of the image capturing device. The light source may for instance be an optic fibre operable to carry light from an external source to the scene. Although also not shown in FIGS. 2a and 2b, the image capturing devices may also comprise optical adjustments means such as one or more lenses which are operable to focus the light from the scene such that clear and accurate images of the scene can be captured by the digital imaging device.

As previously described, stereoscopic three-dimensional (S3D) surgical imaging systems have recently been manufactured. An S3D surgical imaging system is substantially similar to the surgical imaging system depicted in FIG. 1, however, the processor 13 and the display device 14 are operable to process and display a sequence of S3D images, respectively. In an S3D surgical imaging system a sequence of pairs of stereoscopic images are captured by an image capturing device and transmitted to the processor. The pairs of images correspond to a right-hand eye and a left-hand eye image, and the processor 13 processes the captured images utilising methods known in the art so that the images are suitable to be displayed on the display device 14. The sequence of pairs of images may be displayed to a surgeon in accordance with any one of a number of techniques well-known in the art for displaying S3D video, for example, anaglyph, polarised, active shutter or auto-stereoscopic based techniques.

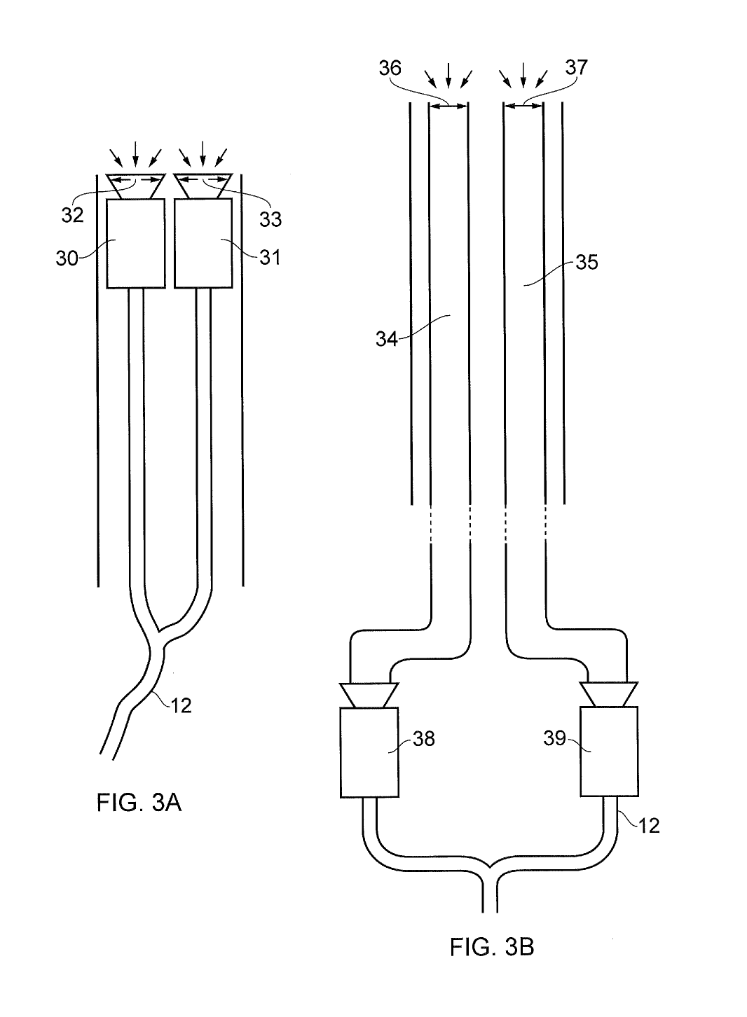

FIGS. 3a and 3b show schematic diagrams of S3D image capturing devices. Elements of the devices illustrated in FIGS. 3a and 3b are substantially similar to those illustrated in FIGS. 2a and 2b, however, the image capturing devices in FIGS. 3a and 3b have two apertures, two digital imaging devices and, in the case of FIG. 3b, two sets of optic fibres. These devices operate substantially similarly to the image capturing devices of FIGS. 2a and 2b except that a pair of stereoscopic images of the scene are captured and transmitted to the processor. The two apertures 32, 33 of FIGS. 2a and 36, 37 of FIG. 2b are horizontally separated in a similar manner to an S3D television camera and the stereoscopic pair of images of a scene captured by the image capturing device appear shifted relative to each other as a result of the different position of the apertures.

As described with reference to FIGS. 2a and 2b, optical adjustment means such as lenses may also be present in the image capturing devices of FIGS. 3a and 3b and suitable alternatives to the digital imaging devices may also be used. In the examples shown in FIGS. 3a and 3b, due to the presence of two apertures, two sets of optical adjustments means will be required in order to ensure that a stereoscopic pair of focussed, clear and accurate images are captured by the digital imaging devices and communicated to the processor. The image capturing devices of FIGS. 3a and 3b may also comprise a light source similar to that described with reference to the image capturing devices of FIGS. 2a and 2b.

Minimising a cross-sectional area of an image capturing device such as those illustrated in FIGS. 2a and 2b, and FIGS. 3a and 4b may assist in reducing a size of an incision required to introduce an image capturing device into a patient. A cross-sectional area of a 2D image capturing device comprising a single aperture and digital imaging device is primarily determined by a size of the aperture and the digital imaging device. However, when an image capturing device comprises two apertures and two digital imaging devices the inter-aperture separation and mechanisms required to control the aperture positions relative to each other also contribute towards the cross-sectional area. Consequently, although the principal of operation of an S3D image capturing device in a surgical imaging system is similar to that of an S3D television camera, a number of features which are commonly found on S3D television cameras may not be found in a surgical S3D image capturing device in order to minimise its size. For instance, a position of apertures 32, 33, 36, 37 may be fixed such that their separation, pitch, roll and yaw is constant, and the apertures may be fixed in parallel such that their convergence point is at an infinite distance. In a conventional S3D television camera, the aforementioned attributes are controlled in response to a number of factors in order to ensure that the captured S3D images can be comfortably viewed by a viewer. For example, the attributed may be controlled in response to a distance to a scene being imaged and a desired relative depth of features of a scene.

As a result of a reduced level of control over the relative positions of the apertures and digital imaging devices in a surgical S3D image capturing device, a number of problems may occur. For instance, an S3D image capturing device is likely to operate within small spaces inside a human body when imaging a scene. Consequently, a ratio of a separation of the apertures to a distance to the scene from the apertures is likely to be large in comparison with a standard S3D camera. Captured S3D images of the scene will therefore have a large range of depth which may cause a surgeon discomfort when viewing the images because human eyes have a limited range of convergence and divergence within which viewing stereoscopic images is comfortable. A second problem may originate from a parallel alignment of the apertures and digital imaging devices. As previously described, parallel alignment of the apertures gives the image capturing apparatus an infinite convergence point. Therefore, when the captured images are presented to a viewer all features in a scene will appear to be in front of a display device displaying the S3D images. This may once again be uncomfortable for a surgeon to view.

A processor such as that depicted in FIG. 1 may adjust the apparent depth of captured images using post-processing methods known in the art but an extent to which this can be done is limited to the maximum depth range that a human can comfortably view. Consequently, the aforementioned factors may reduce the accuracy of S3D images displayed to a surgeon, thus potentially reducing an accuracy of surgery. Furthermore, if parameters of the captured S3D images are not correctly adjusted, viewing of the images may lead to increased surgeon fatigue and an associated reduction in a quality of surgery. Accordingly, means for a surgical imaging system to present depth information that mitigate the problems detailed above is required.

In accordance with a first embodiment of the invention, distance visualisations that provide depth and distance information on points in a scene in an alternative manner to S3D images are presented to the user of a surgical imaging system via a composite 2D image which has been formed from a captured image of the scene.

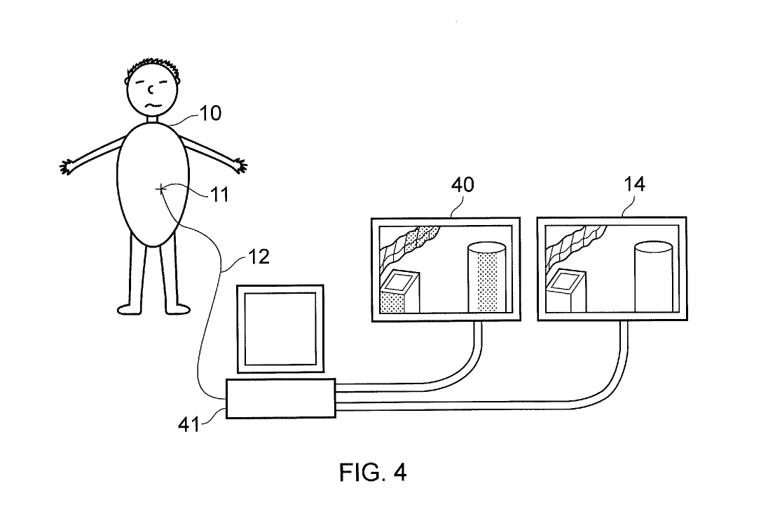

FIG. 4 schematically illustrates a surgical imaging system in accordance with the first embodiment of the invention. The surgical imaging system has a number of features in common with the system illustrated in FIG. 1 and therefore only features which differ from those in FIG. 1 are described below.

The surgical imaging system also includes but is not limited to a second display device 40 operable to display a composite 2D image alongside the display 14 which displays 2D or S3D images directly from the image capturing device. The image directly from the image capturing device may be a 2D image captured by the image capturing device of FIGS. 2a and 2b, one of a stereoscopic pair of images captured by the image capturing devices of FIGS. 3a and 3b, or an S3D image captured by the image capturing devices of FIGS. 3a and 3b. In some embodiments the system may also comprise a third display device such that a 2D image, a composite 2D image and an S3D image may be displayed simultaneously. The surgical imaging system also comprises a processor 41 which corresponds to the processing means 13 of FIG. 1 but with additional processing capabilities that are described below. The processor may be a general purpose personal computer as illustrated in FIG. 4, the computer including at least a central processor unit, a graphics processor and memory. Alternatively the processor may be implemented as a dedicated application specific image processing device such as a 3D processing apparatus.

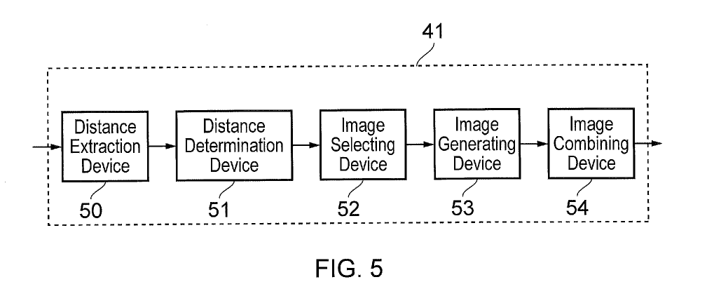

FIG. 5 schematically illustrates processing of the captured images by the processor 41 in accordance with the first embodiment of the invention. The processor 41 comprises at least one of a distance extraction device 50, a distance determination device 51, an image selecting device 52, an image generating device 53, and an image combining device 54. Each of these devices is described in further detail below. The features of the processor are dependent upon the type of image capturing device, i.e. 2D or S3D and the system implementation, consequently, only a subset of the processes depicted in FIG. 5 may be required in some embodiments of the invention.

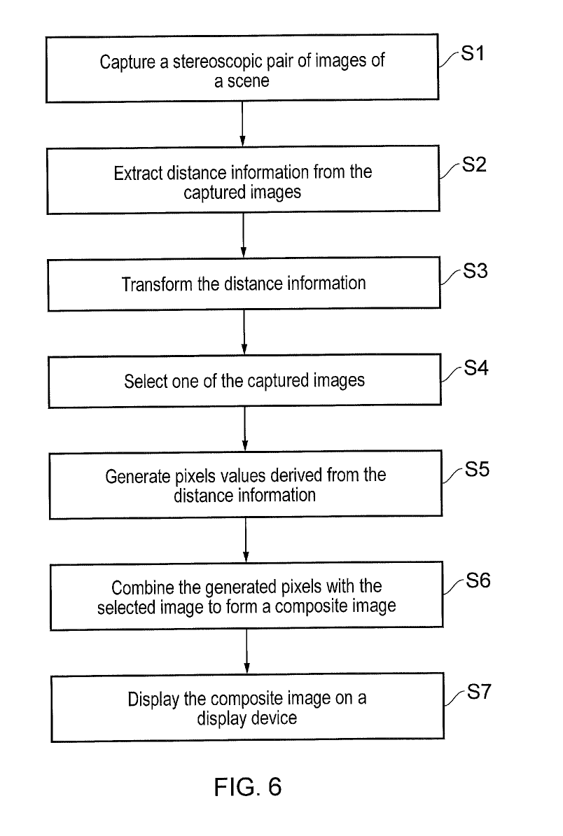

FIG. 6 illustrates a method of operation of a surgical imaging system according to an embodiment of the invention which comprises an S3D image capturing device. The process steps correspond to the operation of the image capturing device, the processor of FIG. 5 and the display devices 14 and 40. The process steps of FIG. 6 shall now be described with reference to FIGS. 5 and 6.

At step S1, an image capturing device captures a stereoscopic pair of images of a scene as described with reference to the image capturing devices of FIGS. 3a and 3b. The captured images may be one of a sequence of pairs that form a video and the captured images are communicated to the processor 41 via the communication line 12. Once the captured images have been communicated to the processor they are sent to the distance extraction device 50.

At step S2, the distance extraction device 50 extracts distance information from the captured images. The distance information includes distance measurements between the image capturing device and points in the scene as well as angles of elevation and rotation between the image capturing device and points in the scene. The extracted distance information is then passed to the distance determination device 51.

The distance extraction device 50 extracts distance measurements between the image capturing device and points in the scene using a disparity between corresponding pixels in the pair of captured stereoscopic images which equate to points in the scene.

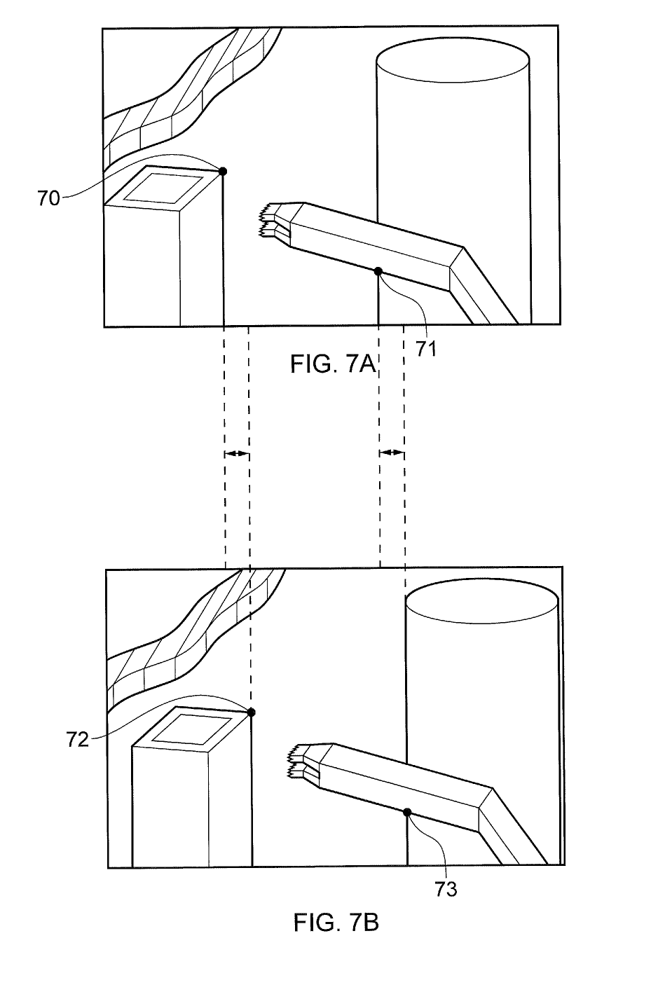

Stereoscopic images are shifted versions of each other and the shift between the images is termed a disparity. FIGS. 7a and 7b illustrate a disparity between pixels in a stereoscopic pair of captured images of a scene where FIG. 7a depicts a right-hand captured image and FIG. 7b depicts a left-hand captured image. The dashed lines between FIGS. 7a and 7b illustrates the disparity between corresponding pixels 70 and 72, and 71 and 73 in the images. The right-hand and left-hand captured images are analogous to images presented to a human brain by a person's right and left eye. The human brain utilises the disparity along with other information to provide depth perception on the scene.

The distance extraction device 50 extracts a distance measurement between the image capturing device and point in the scene from a pair of stereoscopic images using the disparity between pixels that equate to the point. However, in order to extract depth or distance information on a point in a scene a number of measurements and image capturing device parameters are also required in addition to the disparity between the corresponding pixels. A distance between the image capturing device and a point in a scene is a function of parameters of the image capturing device, including the inter-axial separation of the apertures, the horizontal field-of-view (FOV), which can be derived from the focal length and digital imaging device sensor size, and the convergence point of the apertures. Consequently, for the distance extraction device to calculate a distance measurement between the image capturing device and a point in the scene, all of the aforementioned parameters are required in addition to the disparity.

For example, if axial separation of the apertures (i), the horizontal FOV of the image capturing device (FOV), the convergence point of the apertures, and the horizontal disparity between the corresponding pixels in twins of a fraction of the screen (dₓ) width are known, the distance (d) from the image capturing device to the image plane in the Z dimension can be calculated according to

$$d = \frac{i}{{d}_{x} tan ( FOV )}$$

The parameters of the image capturing device may be pre-known or available from metadata communicated by the image capturing device, for instance, the inter-aperture separation and the convergence point are likely to be fixed and known and the focal length able to be obtained from metadata for devices where it is not fixed. Due to the size constraints of medical imaging devices such as endoscopes for example, the focal length is likely to be fixed and therefore metadata may not be required. In other devices such as surgical microscopes for example there may be a range of pre-set focal lengths and magnifications and therefore metadata may be required.

To obtain a disparity between corresponding pixels in a pair of stereoscopic images, corresponding pixels in the pair of images that equate to a same point in the scene are required to be identified and the difference between their locations established. A range of methods and products exist for identifying corresponding pixels or features in images, for example block matching would be an appropriate approach. Another example is feature matching which operates by identifying similar features in one or more images through the comparison of individual pixel values or sets of pixels values. Once corresponding pixels have been obtained, a disparity between these pixels can be calculated and a distance between the image capturing devices and the equivalent point in the scene extracted. In some embodiments of the invention, feature matching will be performed on all individual pixels in the captured images such that distance measurements can be extracted on all points in the scene. However, such a task is likely to be computationally intensive. Consequently, more extensive feature matching presents a trade-off between higher resolution distance information and computational complexity. Furthermore, it may not be possible to match all pixels in the images and thus extract distance information on all points in a scene. In this scenario, in order to extract distance information on all points in a scene it may be necessary to perform interpolation between known corresponding pixels in order to obtain distance information on the intermediate pixels and the points to which they equate. Interpolation is likely to be less computationally intensive than feature matching and therefore the aforementioned approach may also be applied if there is insufficient computing power to carry out feature matching on every pixel in the captured images. However, although interpolation may reduce the computational requirements relative to performing feature matching on every pixel, it may result in reduced accuracy distance information because the interpolation process may not be able account for sharp changes in distance in between two known pixels and the points in a scene to which they equate.

At step S3, the distance information extracted by the distance extraction device may be transformed by the distance determination device when distance information and measurements between two points which do not include the image capturing device are required. The distance determination device transforms the distance information such that distance information is relative to a point which is different to the image capturing device and possibly not in the scene. In one embodiment of the invention the image distance determining device transforms distance information in order to provide distance measurements between a reference point which is not the image capturing device and a point in the scene. For instance, the reference point may be chosen by the surgeon as a blood vessel in the scene and all distance information attributed to points in the scene is with respect to the blood vessel instead of the image capturing device. To transform distance information the distance determination device requires further information such as angles of the reference point and points in the scene with respect to the image capturing device or a location of the reference point relative to the image capturing device. The distance determination device may then use standard trigonometry to arrive at the required transform and distance information. For example, the distance determination device may wish to determine the distance between two points A and B in a scene, neither of which is the image capturing device. The steps to perform such a method are now explained. The distance determination device receives distance information comprising distance measurements in the Z dimension between points A and B in the scene and the image capturing device from the distance extraction device. Angles of elevation and rotation of the points A and B relative to the image capturing device are also received by the distance determination device from the distance extraction device. The angles of elevation and rotation are calculated by the distance determination device from the positions of the pixels in the captured image that equate to points A and B, and the FOV of the image capturing device, whereby a pixel in the captured image equates to an angular fraction of the FOV. With the knowledge of the angles and distances, 3D coordinates of the points A and B relative to the image capturing device can be calculated. These coordinates in conjunction with the 3D version of Pythagoras's theorem are then used to calculate the distance between the points A and B, thus forming the transformed distance information. For example, if the 3D Cartesian coordinates of point A in centimetres are (2, 6, 7) and those of B are (4, 8, 10), the difference between the coordinates can be found and Pythagoras's theorem applied. In this example the difference between the sets of coordinates of points A and B is (2, 2, 3) cm which gives a distance between the points of approximately 4.123 cm.

At Step S4, the image selecting device 52 selects one image from a pair of the most recently captured stereoscopic images. The image generating device and image combining device require a single image on which to perform their processing and therefore when a pair of images is simultaneously captured by an S3D image capturing device, either a right-hand or left-hand image is required to be selected. The image selecting device selects an image dependent on user input or a predefined criterion if no user preference is recorded. The selected image upon which processing is performed after the distance determination device is termed the “selected image” or “duplicate selected image”.

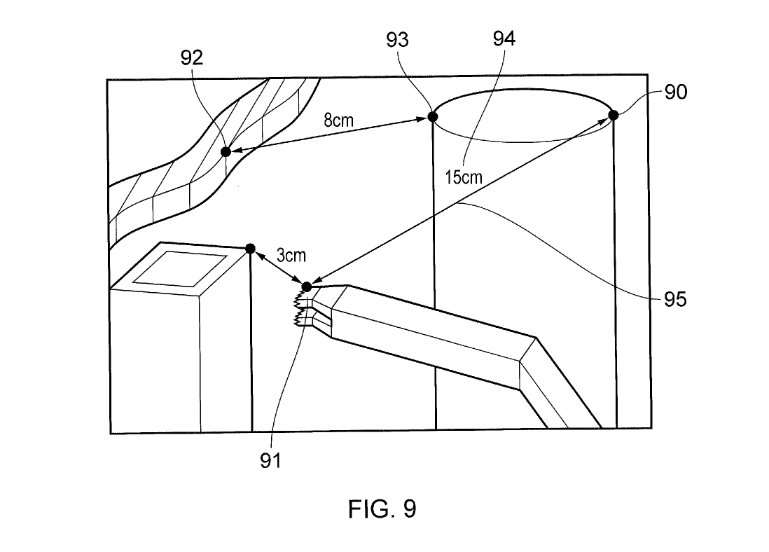

At step S5, pixels which form distance visualisations are generated by the image generating device 53. The values of the generated pixels are at least partially derived from the distance information and the distance visualisations convey distance and depth information. The generated pixels are communicated to an image combining device which utilises the generated pixels to form a composite image that a surgeon views on the display device 40 such that distance and depth information is conveyed to the surgeon via the distance visualisations. The distance visualisations provide an alternative means to S3D images to convey distance and depth information of a scene to a surgeon. The values of the generated pixels are derived from at least one of the following: the distance information provided by the distance extraction device, transformed distance information provided by the distance determination device, the form of the distance visualisation and pixel values of associated pixels in the selected image. The image generator generates pixel values for one or more pixels which are associated with pixels in a selected image. For example, the image generating device may generate a pixel that is associated with a chosen pixel in the selected image where the value of the generated pixel is a function of at least one of the distance data attributed to the chosen pixel by the distance determination device, the value of the chosen pixel, and the distance visualisation. In another embodiment, the value of generated pixels may be dependent on distance data attributed to pixels in close proximity to the chosen pixel that the generated pixel is associated with. The colour of generated pixels may also be partially dependent on the colour or other value of their associated pixel in the selected image. Examples of distance visualisation and methods to generate pixels which form them are described in further detail below with reference to FIGS. 9 to 11.

At step S6, the image combining device 54 is operable to receive generated pixels from the image generating device and to combine the generated pixels with a duplicate of the selected image. The combination of the generated pixels and the duplicate selected image forms a composite image that comprises a distance visualisation formed from the generated pixels. The combination process includes replacing pixels of the duplicated selected image with their associated generated pixels to form the composite image. Once the composite image has been formed it is then transmitted to display device 40 for displaying to a surgeon.

At step S7, the composite image is received from the image combining device and displayed on the display device 40. As previously described the composite image may be displayed alongside the selected image and the S3D image or in place of the S3D image. The images may be displayed either on separate displays or in some embodiments of the system on a single split screen display.

The method described with reference to FIG. 6 refers to a method of operation of an S3D surgical imaging system. Consequently, it would be appreciated by the skilled person that to form a method of operation of a 2D surgical imaging system a number of the steps of FIG. 6 will be different. In particular, a single image will be captured by the image capturing device at step S1, distance information will be extracted via a distance sensor at step S2, and step S4 is not required because only a single is captured during step S1.

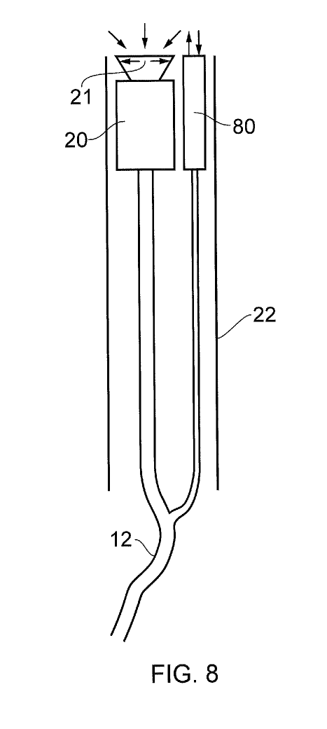

At step S2 of the method illustrated in FIG. 6, in embodiments which comprise a 2D image capturing device the distance extraction device 50 obtains distance information on points in the scene from a distance sensor or equivalent distance measuring device. Such sensors are known in the art and directly measure distances between points in the scene and the image capturing device. Utilisation of a dedicated distance measurement sensor circumvents the need for an S3D image capturing device because the disparity information is not required in order to obtain distance information. Therefore, the distance extraction device of this embodiment is operable to be used with a 2D image capturing device. Furthermore, with the use of a distance measurement sensor in a 2D image capturing device, distance information may be able to be obtained by the image capturing device whilst maintaining a small cross-sectional area because a second aperture and digital imaging device is not required. However, a space saving resulting from the removal of an aperture may be offset by the size of a transmitter and receiver for the distance measuring device. FIG. 8 illustrates an image capturing device in accordance with this embodiment of the invention. The image capturing device is similar to the one depicted in FIG. 2a but additionally comprises a distance measurement sensor 80. The distance measurement sensor is illustrated as a discrete device in FIG. 8 but it may also be integrated into the digital imaging device 20 in order to reduce the cross-sectional area of the image capturing device. A variety of distance measuring sensor known in the art are suitable to be implemented as described above, for example infrared distance sensors.

Due to the augmented nature of the composite image with respect to the selected image, points of the scene may be obscured in the composite image. Consequently, as described above with reference to FIG. 4 and step S7, the composite image may be displayed in addition to the selected image and or an S3D image such that both images are displayed to a surgeon. Displaying a composite image in addition to a selected or S3D image also provides a surgeon with an option of using the composite image as a reference image whilst using another image (either 2D or S3D) as the main image which they guide their work from. Several different combinations of images may be displayed but in order to provide a surgeon with depth and distance information at least one of the images should be an S3D image or a composite image. In circumstances where remote consultation is taking place, the composite images may be streamed to a location different to where the surgery is taking in order for another surgeon to view and consult on the on-going surgery. In some embodiments, only a subset of the images available to the surgeon performing the procedure may be streamed to the remotely consulting surgeon. For example, the 2D and composite image may be streamed to the remotely consulting surgeon whilst the surgeon performing the procedure is able to view the S3D, composite and 2D images of the scene.

In some embodiments of the invention the processor 41 may also comprise a recording device which is operable to record at least one of the captured images, selected images and composite images. Due to the real-time nature of surgery, the above described features 50, 51, 52, 53 and 54 and method of FIG. 6 may operate substantially in real-time such that the composite image and the selected image form one frame of a real-time video of the scene. In such embodiments, any delay introduced by the processing means should be minimised so that there is no noticeable to the user of the system. For example, it is known in the art that delays exceeding 3 frames when viewing a real-time video are noticeable. Accordingly any delay introduced by the processing means should be below the equivalent period of three frames in a 30 frames per second video system.

In embodiments of the invention where the surgical imaging system comprises an S3D image capturing device, S3D images are likely to become uncomfortable to view under circumstances. This may happen for example when the depth of the image becomes greater than the depth a human can comfortably view. A likelihood of such circumstances occurring may be increased when all features of a scene appear to be in front or behind of the screen because approximately only half of the depth budget is available. The features of a scene all appearing in front may occur for example due to a parallel alignment and therefore infinite convergence distance of the apertures of the image capturing device. As previously mentioned, a 2D image may also be simultaneously displayed on another screen and therefore a surgeon will still have access to at least one image of a scene. However, when the S3D image becomes uncomfortable to view the surgeon may lose all depth information on the scene because they may only be able to view a 2D image being simultaneously displayed. When this situation occurs, at step S7 the processor may be configured to display the composite image in place of the S3D image if the composite image is not already display on another display device. The switching between S3D and composite images may be initiated by a surgeon using the system or may be carried out automatically when the processor detects that the depth of an S3D image exceeds a certain threshold which has been automatically defined or defined by the surgeon via a user interface.

In some embodiments of the invention the processor is operable to accept user input so that a surgeon is able to configure the system to their needs. For instance, the surgeon may be able to select a reference point with which the distance determination device transforms distances with respect to, to control switching between displaying a composite image or S3D image on a display, and to select a distance visualisation which is displayed by the composite image. User input may be inputted through a keyboard and mouse arrangement connected to the processor, where a pointer is superimposed on the displayed composite image to indicate to a surgeon their input. Alternatively, the display device may be operable to accept gesture based input such as touching a screen of a display device. A touchscreen user interface input would allow a surgeon to quickly and easily select a reference point in the composite image they desire the distance information provided by the distance determination device to be with respect to. Due to sterile nature of operating theatres, a touchscreen based user interface also provides a surface which is easy to clean, thus also providing cleanliness advantages in comparison to input devices such as keyboards and mice.

At step S5 of FIG. 6, the image generating device 53 generates pixels which form a range of alternative distance visualisations. Each of the distance visualisations uses a different visual means to convey distance and depth information to a surgeon viewing the composite image. These distance visualisations therefore provide alternative means to an S3D image to deliver depth information to a surgeon using a surgical imaging system. The distance visualisation presented by the composite image may be selected and configured to convey specific distance information by the surgeon via the user input means previously described.

In one embodiment of the invention the image generating device generates pixel values for a plurality of pixels which form a numerical distance visualisation, the pixel values being dependent on distance data either provided by the distance extraction device or the distance determination device. The generated pixels form a numerical distance visualisation which, after the generated pixels have been combined with a duplicate of a selected image, presents a numerical distance measurement which conveys distances between points in a scene. FIG. 9 illustrates the numerical distance measurements formed by the generated pixels when the composite image is displayed on a display device. The numerical distance visualisation presents a distance measurement 94 between a pair of pixels 90, 91 which equate to points in a scene. Examples of the points include two points within the scene, a reference point external to the scene and a point in the scene, and a point in the scene and the image capturing device. Pixels forming numerical distance visualisations corresponding to a plurality of pairs of points 90, 91 and 92, 93 may also be generated by the image generator. The numerical distance measurements may refer to distances in all three dimensions of the scene such that the numerical distance visualisation may convey depth, width and height information. The pixel values generated by the image generating device are different to the value of the pixels they are associated with in the selected image, and a colour of the generated pixels may be selected by a surgeon. For example, if a colour of a pixel associated with a generated pixel is red, the generated pixel may be yellow or any other suitably distinct colour. The units of the numerical distance measurement may also be selected by the surgeon according to their preference where any conversion between measurement units is performed by the distance determination device. The image generating device may also be operable to generate pixels that form a line 95 between two pixels 90, 91 in the composite image, the line assisting a surgeon in identifying pixels in the composite image which the numerical distance measurement refers to.

Providing numerical distance measurements via the composite image allows a surgeon to quickly and easily keep track of the sizes and distances in the scene that may be difficult to determine manually. For example, the numerical distance visualisation may be utilised when a surgeon is positioning a medical device within a patient and the device is required to be positioned a predetermined distance from an area of tissue. Alternatively, if a surgeon is making an incision, the numerical distance visualisation may be configured to display the size or area of the incision. This enables the surgeon to accurately establish the dimensions of any incision which has been made where previously the surgeon would have been required to estimate the dimensions of an incision. In this circumstance it may be required that the surgeon configure the image generating device to present a distance measurement between two or more dynamic reference points, i.e. the start and end point of the incision or three or more points that define an area, where the one or more dynamic reference points may be tracked using an image tracking technique known in the art or tracked manually by the user.

In one embodiment of the invention the image generating device may be operable to notify the surgeon if a measurement between two points exceeds a certain limit by sounding an alarm or displaying a visual notification. For example, if it is vital that a tear in a tissue does not exceed a certain dimension during a surgical procedure, the image generating device could be configured to notify the surgeon if the tear is approaching this limit.

In an alternative embodiment, numerical distance measurements between points in the scene may be monitored by the image generator but are only displayed if they approach a threshold. This ensures that a surgeon is not distracted by unnecessary distance visualisation whilst performing surgery. Overall, numerical distance visualisations provides a surgeon viewing the composite image with improved information on the area that surgery is taking place whilst not adversely affecting a surgeon's concentration.

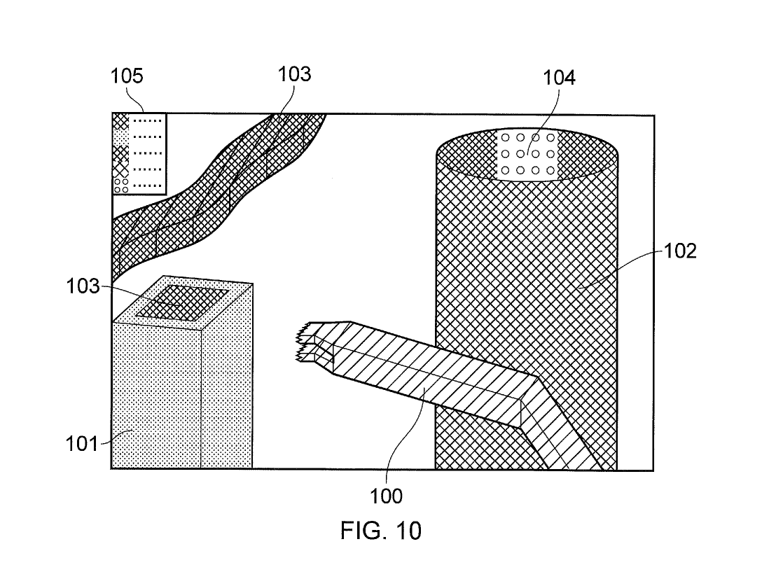

In another embodiment of the invention the image generating device generates pixel values for a plurality of pixels which form a colour based distance visualisation, the pixel values being dependent at least on distance data either provided by the distance extraction device or the distance determination device. The colour based distance visualisation conveys distances between points in a scene by colouring the generated pixels according to distance that their equivalent point in the scene is from a reference point such as the image capturing device. The colour of the generated pixels may be wholly dependent on distance information in scene but in some embodiments their colour may also be partially dependent on distance information and the colour of the pixel in the selected image which the generated pixel is associated with. Partial dependency of this nature gives the impression that colour which conveys distance information has been superimposed on top of the selected image, therefore partially preserving the original colour of the selected image. FIG. 10 illustrates a colour based distance visualisation formed by the generated pixels when the composite image is displayed on a display device. The image combining device replaces pixels of the duplicate selected image with their associated generated pixels to form a composite image. The dependency of the colour of the generated pixels on distance information results in a colour map where the colour of the composite image reflects the distance between points in the scene and a reference point.

In FIG. 10, different shading patterns represent different colours and a different distance from the reference point. In FIG. 10 the reference point is the image capturing device and the single line shading 100 represents the area of the scene nearest the image capturing device and, in ascending order, dotted shading 101, coarse cross-hatched shading 102, fine cross-hatch 103 and circular shading 104 represent areas which are further from the image capturing device. When a colour based distance visualisation is presented by the composite image, a key 105 defining the distance each colour represents may also be presented.

The distances between points may be formed into groups according to their magnitude i.e. 0-5 mm group, 5-10 mm group and so forth, and pixels equating to points in each group may have a same value such that substantial areas of a same colour are presented by the composite image. Alternatively, every pixel which equates to a point in the scene which is at a different distance from a reference point may be allocated a different colour such that there is a continuous colour spectrum in the composite image. For example, generated pixels equating to points closest to the image capturing device may be coloured red and pixels equating to points farthest from the reference points may be coloured blue. Pixels equating to points at intermediate distances would therefore have colours ranging from red to yellow to green to blue depending upon their distances from the reference point.

The resolution of colour maps may also be adapted to suit the environment of the scene which they are displaying, thus providing information which is tailored to the requirements of a surgeon viewing the composite image. For instance, pixels of a captured image may be grouped into sets and a colour of the pixels in the set being dependent upon the average distance between the points in the scene which the pixels equate to and the reference point. Alternatively, the colour of each individual pixel may be dependent only on the distance between its equivalent point in the scene and a reference point.

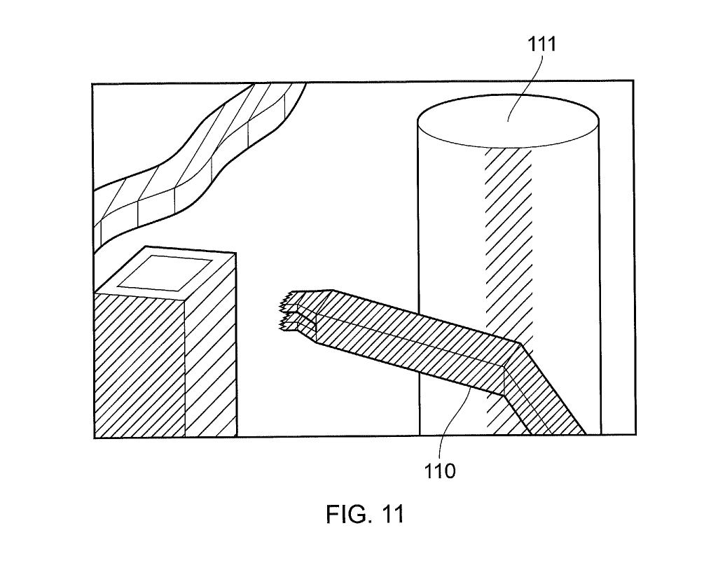

In another embodiment of the invention the image generating device generates pixel values for a plurality of pixels which form a chrominance saturation based distance visualisation, the pixel values being dependent on distance data either provided by the distance extraction device or the distance determination device. The generated pixels form a chrominance saturation based distance measurement such that, after the generated pixels have been combined with a duplicate of a selected image, the chrominance saturation of pixels of the composite are dependent upon a distance that their equivalent point in the scene is from a reference point. FIG. 11 illustrates the chrominance saturation distance visualisation formed by the generated pixels when the composite image is displayed on a display device.

In FIG. 11, the chrominance saturation (illustrated as a level of shading) represents a distance between points in the scene and the image capturing device. Consequently, pixels which equate to points of the scene close to the image capturing device have a high saturation 110 and pixels which equate to points which are further from the image capturing device have a lower saturation 111. The advantages described above with reference to the colour based distance visualisation are equally applicable to a chrominance saturation distance visualisation but a number of further advantages may also arise. For instance, adjusting the chrominance saturation of the pixels to reflect a distance between their equivalent points in the scene and a reference point preserves the colour of the scene. In a surgical environment this may be beneficial because features of the scene with distinct colours may be more recognisable. For example, if a tissue such as a vein ruptures it is of vital importance that the surgeon is aware of this event as quickly as possible. If the colour of the scene has been adjusted a colour of the blood may be less noticeable and therefore an increased amount of time may pass before the rupture is noticed. If the chrominance saturation of the pixels is altered events such as a vein rupture and associated blood may be more quickly recognised compared to when the colour of the pixels is adjusted.

User controls described above provide means for a surgeon to control a placement of a reference point in the scene and allow the surgeon to switch between the alternative depth visualisation described above. For instance, if a surgeon's primary concern is the size of an incision the surgeon may select the numerical distance measurement visualisation. Alternatively, if the surgeon wishes to primarily concentrate on features of the scene close to a surgical tool, the surgeon may select a chrominance saturation based visualisation and position a reference point on the surgical tool, therefore the areas of the scene in close proximity to the surgical tool will be most prominent because they have a higher saturation. The ability to select the distance visualisation further enables the surgeon to tailor the composite image to their preferences, therefore potentially improving the accuracy of surgery. In this example the reference points may once again be tracked using image tracking techniques known in the art or manually tracked by a user.

In some embodiments of the invention the reference point may be user defined and the distance determination device transform extracted distance information such that distances conveyed by a numerical distance visualisation may represent distances to an important feature in the scene. In addition to this, the reference points may also be dynamically repositioned so that it is possible to associate a reference point with a feature in the image which is moving|. |[g2]For example, in some circumstances it may be useful for a surgeon to know the distance between an operating tool and tissues in the patient. In such a scenario the surgeon may choose to associate the reference point with the tip of a scalpel and a resulting distance visualisation will convey distances between the tip of the scalpel and other points in the scene. In this case, the relationship between the scalpel and the camera would be fixed or known.

In addition to the embodiments described above, other distance visualisations may also be formed from pixels generated by the image generating device. For example, in some embodiments the values of generated pixels may be taken from a position along a dimension of a colour sphere, where the position along the dimension of the colour sphere is determined by the distance between a point in the scene the pixel equates to and a reference point.

In another embodiment of the invention the value of pixels generated by the image generating device may be dependent on a rate of change of a distance between points in the scene that the generated pixels equate to and a reference point. A distance visualisation formed from these generated pixels may for example be of use to a surgeon when sudden changes in a size of an area of tissue are to be avoided. In a similar manner to the previously described numerical distance visualisation, the surgeon may be notified if a rate of change of a distance or area exceeds a threshold. For instance, an area of tissue which experiences a rapid change in its dimensions may be brought to the surgeon's attention by highlighting it with a distinctive colour.

Although embodiments of the invention have been described with reference to use by a surgeon, the invention hereinbefore described may also be used or operated by any suitably qualified individual who may be referred to as a user. Furthermore, although embodiments of the invention have also been described with reference to surgical imaging of a human body, the invention is equally applicable to surgical imaging of an animal's body by a veterinarian or other suitably qualified person.

Furthermore, although embodiments of the invention have been described with reference to surgical imaging devices and surgery, they may also be used in alternative situations. Embodiments of the present invention may include a borescope or non-surgical 3D microscope and may be used in industries and situations which require close-up 3D work and imaging, for example, life sciences, semi-conductor manufacturing, and mechanical and structural inspection. In other words, although embodiments relate to a surgical imaging device and system, other embodiments may relate to an imaging inspection device and or system.

Obviously, numerous modifications and variations of the present disclosure are possible in light of the above teachings. It is therefore to be understood that within the scope of the appended claims, the invention may be practiced otherwise than as specifically described herein.|[g3]

In so far as embodiments of the invention have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the invention.

1-33. (canceled)

34. A surgical imaging system comprising:
an image capturing device with circuitry operable to capture an image of a scene;
a distance extraction device circuitry operable to extract distance information from a point in the scene, the distance information being the distance between the image capturing device and the point in the scene;
an image generating device circuitry operable to generate a pixel, the generated pixel being associated with a pixel in the captured image and a value of the generated pixel being derived from the distance information;
an image combining device circuitry operable to combine the generated pixel with the captured image, wherein the generated pixel replaces the pixel of the captured image it is associated with to form a composite image; and
an image display device circuitry operable to display the composite image.

35. The surgical imaging system according to claim 34, wherein the image capturing device is a three-dimensional image capturing device with circuitry operable to capture a pair of stereoscopic images of the scene.

36. The surgical imaging device according to claim 35, further comprising an image selecting device circuitry operable to select one of the pair of captured stereoscopic images, the selected image forming the captured image that is combined with the generated pixel.

37. The surgical imaging system according to claim 36, wherein the distance extracting device circuitry is operable, with knowledge of at least one image capturing device parameter, to extract the distance between the image capturing device and the point in the scene from the pair of stereoscopic images.

38. A surgical imaging system according to claim 37, wherein the at least one image capturing device parameter includes one or more parameters selected from the group comprising a focal length, an aperture separation, a horizontal field of view, a aperture convergence point and a size of a digital imaging device.

39. A surgical imaging system according to claim 34, wherein the image generating device circuitry is operable to generate a plurality of pixels, the plurality of pixels forming a numerical distance measurement and the numerical distance measurement being a measurement between the point in the scene and a reference point.

40. A surgical imaging system according to claim 34, wherein the image generating device circuitry is operable to generate a plurality of pixels, a colour of each of the plurality of pixels being derived from the distance information.

41. A surgical imaging system according to claim 34, wherein the image generating device circuitry is operable to generate a plurality of pixels, a chrominance saturation of each of the plurality of pixels being derived from the distance information.

42. A surgical imaging system according to claim 34, wherein the image capturing device, the distance extraction device, the image generating device, the image combining device and the image display device operate substantially in real-time such that the displayed composite image forms part of a real-time video.

43. A surgical imaging system according to claim 34, wherein the distance extraction device comprises a distance sensor circuitry operable to directly measure a distance between the image capturing device and the point in the scene, the measured distance forming the distance information.

44. A surgical imaging system according to claim 34, the system further comprising a distance determination device circuitry operable to transform the distance information, the transformed distance information forming the distance information and being a distance between a reference point and the point in the scene.

45. A surgical imaging system according to claim 44, wherein the reference point is defined by a user of the system.

46. The surgical imaging system according to claim 34, wherein the generated pixel and its associated pixel in the captured image equate to the point in the scene.

47. A surgical imaging method comprising:
capturing an image of a scene;
extracting distance information from a point in the scene, the distance information being the distance between the image capturing device and the point in the scene;
generating a pixel, the generated pixel being associated with a pixel in the captured image and a value of the generated pixel being derived from the distance information;
combining the generated pixel with the captured image, wherein the generated pixel replaces the pixel of the captured image it is associated with to form a composite image; and
displaying the composite image.

48. The surgical imaging method according to claim 47, the method including capturing a pair of stereoscopic images of the scene.

49. The surgical imaging device method to claim 48, the method including selecting one of the pair of captured stereoscopic images, the selected image forming the captured image that is combined with the generated pixel.

50. The surgical imaging method according to claim 49, the method including, with knowledge of at least one image capturing device parameter, extracting the distance between the image capturing device and the point in the scene from the pair of stereoscopic images.

51. A surgical imaging method according to claim 50, wherein the at least one image capturing device parameter includes one or more parameters selected from the group comprising a focal length, an aperture separation, a horizontal field of view, a aperture convergence point and a size of a digital imaging device.

52. A surgical imaging method according to claim 47, the method including generating a plurality of pixels, the plurality of pixels forming a numerical distance measurement and the numerical distance measurement being a measurement between the point in the scene and a reference point.

53. A non-transitory computer readable medium including computer program instructions, which when executed by a computer causes the computer to perform the method of claim 47.
